(19) United States
(12) Patent Application Publication
(10) Pub. No.: US 2023/0206360 A1
(43) Pub. Date: Jun. 29, 2023

(54) SYSTEM AND COMPUTER-IMPLEMENTED METHOD TO ANALYZE, PREDICT OR AUTOMATE FINANCIAL AND OPERATIVE MANAGEMENT OR ANY ACTIVITIES RELATING TO BUILDINGS BASED ON DATA ABOUT THE SAME BUILDINGS

(71) Applicant: Arianna Del Sol, Montreal, QC (CA)

(72) Inventor: Arianna Del Sol, Montreal, QC (CA)

(21) Appl. No.: 17/998,688

(22) PCT Filed: May 14, 2021
(86) PCT No.: PCT/CA2021/050669

§ 371 Date: Nov. 14, 2022

Related U.S. Application Data
(60) Provisional application No. 63/024,759, filed on May 14, 2020.

(51) Int. Cl. G06Q 50/16; G06Q 30/02; G06Q 30/0201; G06Q 10/20

(52) U.S. Cl. CPC G06Q 50/163; G06Q 30/0278; G06Q 30/0206; G06Q 10/20

(57) ABSTRACT

The present invention provides systems and methods to analyze, predict or automate financial and operative management or any activities relating to buildings based on data about the same buildings. A system and method for automatically managing operations in relation to buildings is also provided. A computer-implemented method and system to calculate financial analysis and/or predictions regarding buildings based on data about the same buildings are provided. A method and system to identify and suggest potential tenants of a building to a user are described and a computer-implemented method and system to map objects on a geographical map is disclosed.

### CROSS-REFERENCE TO RELATED APPLICATIONS

The present patent application claims the benefits of priority of U.S. Patent Application No. 63/024,759, entitled “SYSTEM AND COMPUTER-IMPLEMENTED METHOD TO ANALYZE, PREDICT OR AUTOMATE FINANCIAL AND OPERATIVE MANAGEMENT OR ANY ACTIVITIES RELATING TO BUILDINGS BASED ON DATA ABOUT THE SAME BUILDINGS” and filed at the United States Patent and Trademark Office on May 14, 2020, the content of which is incorporated herein by reference.

### FIELD OF THE INVENTION

The present invention generally relates to systems for analyzing, predicting, or automating financial and operative management or any activities relating to buildings and methods thereof. More particularly, the present invention relates to systems for analyzing, predicting, or automating financial and operative management or any activities relating to buildings based on data about the buildings, on financial data, on geographic data, on data from artificial intelligence processes and/or on external data.

### BACKGROUND OF THE INVENTION

Management of buildings by an owner or a landlord are generally done in person and in a manual or case-by-case basis. In some other cases, landlords hire a property management firm to take over the management of one or more buildings. Generally, the process of managing buildings is time-consuming, costly, and sometimes unpleasant.

As the landlords generally manage the buildings on a case-by-case basis, the associated tenants generally have limited information about the building in which they live and about the process of building management. Nowadays, there is a need for a central point of information containing real-time information about buildings, dynamic market value of the building and value of any repairs or upgraded to the building. The central point of information shall be accessible to all people involved in the management and maintenance of the building, such as landlords, tenants, work suppliers and/or owners.

Some solutions have been disclosed which generally aim at solving some of the abovementioned issues. U.S. Pat. No. 7,143,048 discloses a method of requesting and providing services related to a property between tenants and service providers. The system allows the creation and edition of documents relating to the property, such as contracts, and the creation of service requests by a tenant to the landlord. The system further allows requests of shared services of the building by the tenants, sending requests to vendor of service to be performed and the vendor providing status of the service being performed.

US patent application No. 2005/0144,028 A1 discloses a property management system. The property management system is configured to coordinate an income stream from the tenant to the owner, such as traditional income stream and non-traditional income stream from the coordination of the providers in response to requests of the tenants. The system allows a tenant to send a repair request to the landlord which assigns the task to a service provider. The service provider may update the owner or tenant regarding the status of the work.

Such systems and/or method do not predict requests or operations based on external data and internal data relating to the buildings or the suppliers.

Therefore, there is a need for a system and methods to provide a system or method to analyze, predict or automate financial and operative management or any activities relating to of buildings based on data about the same buildings.

### SUMMARY OF THE INVENTION

The shortcomings of the prior art are generally mitigated by providing a system and method for managing buildings.

In one aspect of the invention, a building management system is provided. The system may be used to communicate information between different users in relation to a building and various services associated to construction. Users may comprise landlords, tenants, service providers and more.

In another aspect of the invention, the system may receive various types of information on a building and users, directly entered from users or obtained from external information sources. The system may further coordinate with a spatial and geographical database or software to send and receive such information relative to the inside and outside of a building and its surrounding environment. The received information may then be validated, filtered, and classified to further be used by the system or users.

In a further aspect of the invention, the system may provide a communication platform for users to send and receive information, tasks or demands in relation to one or more buildings.

In yet another aspect of the invention, the system may provide a platform to track and interact with tasks or demands related to a building. Specific users may track the progress of tasks, such as repairs. Specific users may also interact with the platform to modify or complete tasks before, during or after they are done. Similarly, demands between users may be sent, received, and answered. With a corresponding level of control for a given user, users may manually create or modify such tasks and demands. Part of the platform may also be automated to reduce the time involvement required by users.

In a further aspect of the invention, the system may comprise financial services. The system may liaise with payment platforms to facilitate the exchange of currency for fees related to a building. The system may also receive internal and external financial data to filter, categorize and to further analyze it to provide a variety of associated services.

In an additional aspect of the invention, the system may create simple or complex user profiles with internally or externally provided data. Such profiles may be given different levels of control over certain aspects of the system and its different platforms. More so, the system may filter the profiles database to send specific information to specific users based on predetermined parameters.

In an aspect of the invention, a method of automatizing service providers' requests and work is provided. The method broadly comprises the steps of sending a service request, analyzing the request, sending the request to an appropriate user, accepting or refusing the request for given users, receiving a cost estimate, accepting or refusing the estimate, tracking the work, sending a work report, paying the work fees and rating the service provided.

In another aspect of the invention, a method of analyzing financial predictions for managing one or multiple buildings is provided. The method comprises collecting internally or externally available data about buildings finances and releasing reports and alerts based on analysis performed with specific parameters.

A method of connecting user profiles is also provided. The method comprises filtering user profiles through the system's database and initiating contact between users when their profiles respect predetermined parameters. The method may further send alerts to specific users based on specific research criteria.

In another aspect of the invention, a computer-implemented method for analyzing, predicting or automating the financial and operative management of at least one building is provided. The method comprises retrieving from a server data relating to the at least one building, categorizing the retrieved data using categories, retrieving external data about the real estate market and other buildings, categorizing the retrieved external data using the categories, comparing categorized data relating to the at least one building with the categorized external data for each category, and calculating prediction values based on the compared categories.

The retrieving data relating to the at least one building may comprise cadastral data about the at least one building, current rental prices of apartments of the at least one building, dimensions of the at least one building, market value of the at least one building, specific features of the at least one building or improvements to the at least one building.

The retrieval of external data may comprise retrieving data relating to buildings similar to the at least one building from open data sources, governmental data sources or privately owned data sources. The retrieved external data may comprise occupation rate of the other buildings, market value of the other buildings, duration of sale listings for the other buildings or duration of rental listings for the other buildings.

The method may additionally comprise filtering, cleaning, analyzing and classifying the data relating to the at least one building as well as dynamically determining the categories. The method may further comprise processing the prediction values to derive a target sale price of the at least one building, target rental prices of apartments of the at least one building, target improvements of the at least one building, target marketing terms for the promotion of the at least one building and target marketing strategies for the promotion of the at least one building.

In yet another aspect of the invention, a computer-implemented method for automatically managing relationships between landlord and/or owner, tenants and service providers in relation to a building is provided, the method comprising communicating a request of work to a server from a party involved with the building concerning an issue in relation to the building, processing the request of work received from the building party to generate a request of executing the work, matching the generated request of executing the work to one of the service providers, communicating the generated request of executing the work to the matched service provider, the receiving service provider sending a reply of acceptance or of refusal of the received request of executing the work, and the service provider communicating to the server a date of completion of the work to be executed upon completion of the said work.

The request of work may comprise a category of work, notes from the building party and a specific service provider to be contacted and the processing of the request of work may further comprise extracting information from the request of work relevant to the matching service provider and creating a request for executing the work based on the extracted information. Similarly, the processing of the request of work may further comprise fetching one or more template documents, replacing the extracted information into placeholders of the template document to generate the request for executing the work to the matching service provider, associating a predetermined category to the type of work requested, and fetching a service provider associated with the predetermined category of work.

In an aspect of the invention, one of the service providers associated with the predetermined category may be associated to the building, the method further comprising automatically sending the generated request of executing the work to the associated service provider. When a tenant computerized device sends the request of work, the method may further comprise sending a request of approval to the computerized device of the landlord/owner, the computerized device of the landlord/owner sending a reply comprising approval or refusal of the received request of approval and continuing the processing if the reply comprises an approval. A notification of the refusal to the computerized device of the tenant may be sent if the reply comprises a refusal or a request of approval may be automatic if some predetermined criteria are met. Upon receipt of the reply of refusal of work by the service provider, the method may further comprise the landlord/owner selecting another service provider associated to the generated request to execute work and sending the amended generated request to execute work to the other service provider.

The service provider may input and send to the server the date at which the work is to be executed and an estimate of time of completion of the work and/or transfer data to the server about the completed work, the method thereafter sending a notification that the work is completed to a computerized device of the tenant and/or to a computerized device of the landlord and/or owner.

In still another aspect of the invention, a system for automatically managing relationships between landlord and/or owner, tenants and service providers, in relation to a building is provided, the system comprising a network, a computerized device of a party involved with the building, the computerized device being in communication with the network, the computerized device being configured to create at least one request of work concerning an issue in relation to the building, the request of work comprising a type of work associated with the issue, communicate the created request of work to a server, and receive notifications from the server, a data source comprising data relating to the building, a plurality of types of work, data relating to the service providers, each of the service providers being associated with at least one of the types of work, and a server in communication with the network, the server being configured to process the request of work received from the computerized device of the building party to generate a request of executing the work, communicate the generated request of executing the work to a computerized device of one of the service providers, receive and store a date of completion of the work from the computerized device of one of the service providers, matching the receive request of work to one of the service providers, the computerized device of one of the service providers, the computerized device being in communication with the network, the computerized device being configured to receive the generated request of executing the work from the server, communicate to the server a reply of acceptance or of refusal in relation with the received request of executing the work and communicate to the server a date of completion of the work to be executed upon completion of work of the request of executing the work.

The server may be further configured to associate a predetermined category to the type of work in the received request of work and fetch one or more of the service providers associated with the predetermined category of work. The computerized device of a service provider may be further configured to create and communicate to the server an approval or refusal notification in relation to the generated request of executing the work. Moreover, the data source may comprise an association between one or more of the service providers and the building and the server may be configured to automatically match one of the service providers to the generated request for executing work and to automatically communicate the generated request for executing work to the computerized device of the service provider.

In yet another aspect of the invention, a computer-implemented method to identify and suggest potential users with interest for a building is provided, the method comprising storing information about buildings in a data source, the information comprising information about buildings offered for rent or for sale and users related to each of the buildings, identifying the users stored in the data source that are actively searching for one of the buildings to rent or to buy in the data source, matching the identified users with the buildings available for rent or for sale stored in the data source and sending a notification to one or more of the users related to each of the buildings matched with the identified users actively searching for one of the buildings to rent or to buy.

The method may further comprise categorizing information about the buildings in the data source using categories using an artificial intelligence module to identify the categories, retrieving external data about buildings within a predetermined distance of the buildings in the data source, categorizing the retrieved external data using the categories, comparing categorized data relating to at least one of the buildings of the data source with the categorized external data for each category and calculating a matching score between one of the identified users and one of the buildings based on the compared categories.

The external data being retrieved may comprise data about the real estate market or data of development or construction sites, the method further comprising identifying the buildings of the data source being within a predetermined distance of building developments or construction sites and sending a notification to users relating to the buildings within the predetermined distance of the building developments or construction sites.

The storing of information may further comprise owners of each of the buildings in the data source with the method further comprising matching the buildings of the data source meeting criteria associated with the identified users searching, matching a first owner associated with a building related to one of the identified users searching and a second owner associated with one of the buildings matched to the identified user searching and sending a notification to the first and second owners about the matching of the first and second owners.

The identification of the users stored in the data source that are actively searching for one of the buildings to rent or to buy in the data source may further comprise collecting information about browsing habits of the users when the said users are browsing for buildings in the data source using an artificial intelligence process trained to analyze and filter the collected information about browsing habits of the users.

In another aspect of the invention, a system to identify and suggest a user with interest for a building is provided, the system comprising a network, a data source comprising data about buildings, the information comprising data about buildings offered for rent or for sale and data about users searching for buildings for rent or for sale and users related to the buildings, a computerized device of a user involved with the building, the computerized device being in communication with the network, the computerized device being configured to receive a notification from a server and a server in communication with the network, the server being configured to identify one or more of the users of the data source that are searching for one of the buildings to rent or to buy, match the identified users with one or more of the buildings in the data source that are available for rent or for sale, automatically match the identified users to one or more of the buildings meeting at least one criteria, and send a notification to the computerized device of one or more users associated with the one or more of the buildings, the notification comprising the data about the matched users and the associated one or more of the buildings.

The data source may further comprise external data about buildings within a predetermined distance of the buildings in the data source, the server being further configured to retrieve the external data about buildings and to store the retrieved external data in the data source. The server may also be further configured to categorize information about the buildings in the data source using categories, categorize the retrieved external data using the categories, compare the categorized data relating to at least one of the buildings of the data source with the categorized external data for each category and calculate a matching score between the user and one of the buildings based on the compared categories.

The categories may be dynamically identified and the system may comprise an artificial intelligence module configured to be trained with the external data and to identify the categories based on the training.

The external data may comprise building developments or construction sites, the server being further adapted to identify buildings of the data source being within a predetermined distance of the building developments or construction sites and send a notification to the one or more users relating to the buildings within the predetermined distance of the building developments or construction sites.

In yet another aspect of the invention, a computer-implemented method to map objects on a geographical map is provided, the method comprising retrieving image data of a plurality of buildings from a plurality of data sources, categorizing the retrieved image data using categories, reducing the retrieved image data in a geographic information data source (GIS) comprising movable and semi-movable objects and buildings, identifying each object present in the categorized image data and storing each object in the GIS and associating each of the identified objects to a geographical location.

The retrieval of image data from a plurality of data sources may further comprise fetching image data from cadastral data, satellite data images of the exteriors of the buildings and image data relating to objects to be mapped and the detection of the dimensions and/or the shape of the identified objects may comprise using an artificial intelligence module to train the detection of the said dimensions and/or shapes to allow the detection to be improved over time as the additional image data is mapped. The association of each of the identified object to a geographical location may similarly comprise using an artificial intelligence module to train the detection of the said dimensions and/or shapes to allow the detection to be improved over time as the additional image data is mapped.

The method may further comprise dynamically determining the categories, cleaning the data from any predetermined conditions, filtering the retrieved image data using any predetermined filters and detecting dimensions and/or shapes of each of the identified objects wherein the association of a type of object to each of the identified objects uses the detected dimensions and/or shape. The method may further comprise fetching from the GIS one or more objects linked to a specified coordinate, displaying the fetched object over a map, marking the identified objects as being an interactive object and interacting with the interactive object.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is a block diagram of an exemplary method for automatically managing relationships between landlord and/or owner, tenants and service providers according to the principles of the present invention.

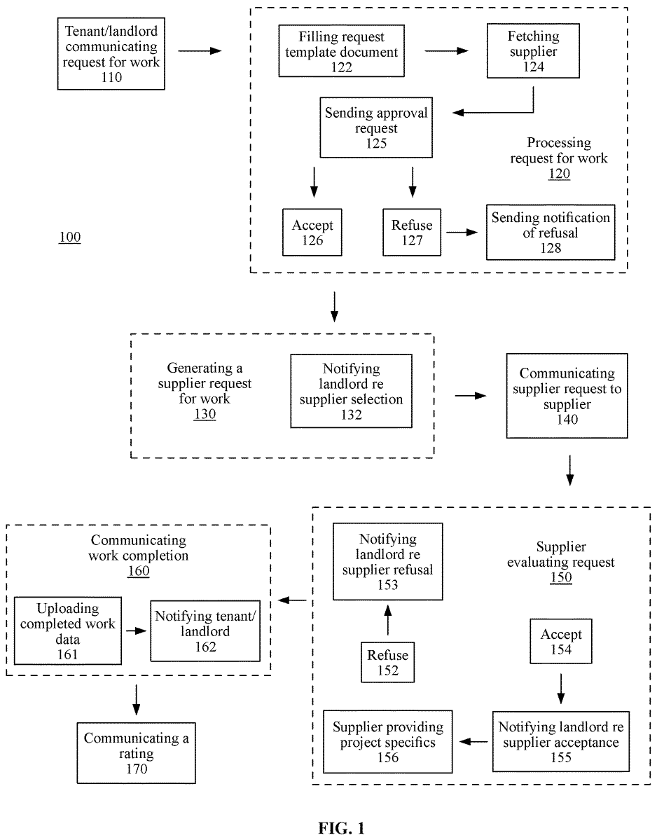

FIG. 2 is an illustration of an exemplary system for automatically managing relationships between landlord and/or owner, tenants and service providers according to the principles of the present invention.

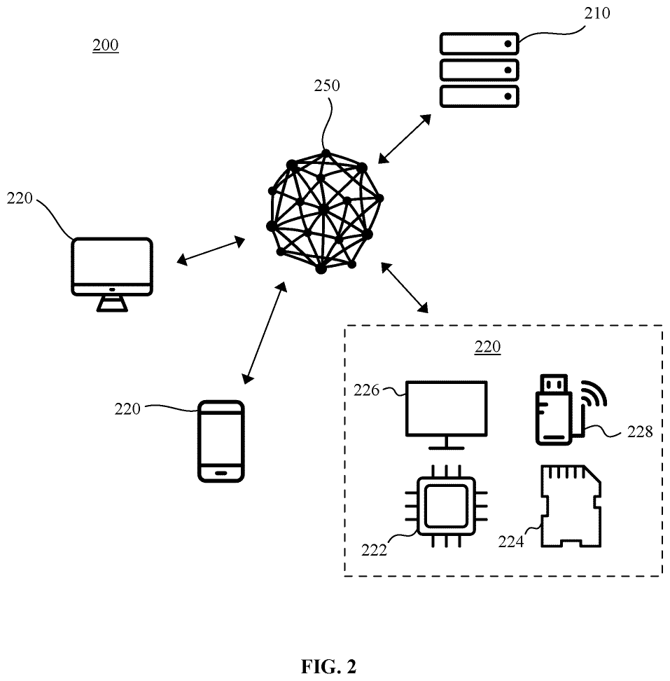

FIG. 3 is a block diagram of an exemplary method for analyzing, predicting or automating the financial and operative management of a building according to the principles of the present invention.

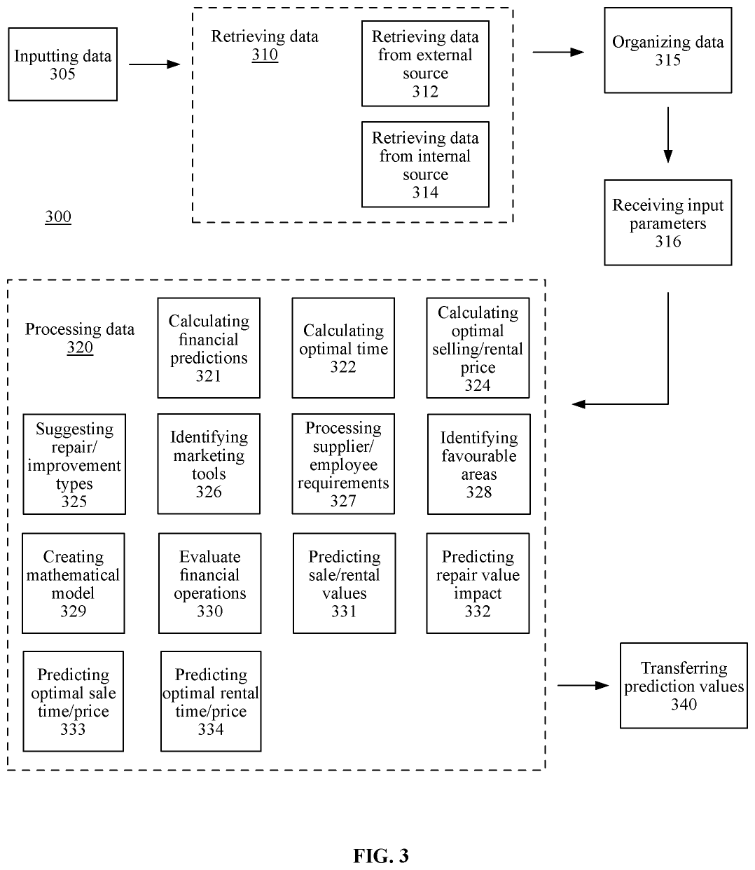

FIG. 4 is a block diagram of an exemplary method for identifying and suggesting potential users with interest for a building according to the principles of the present invention.

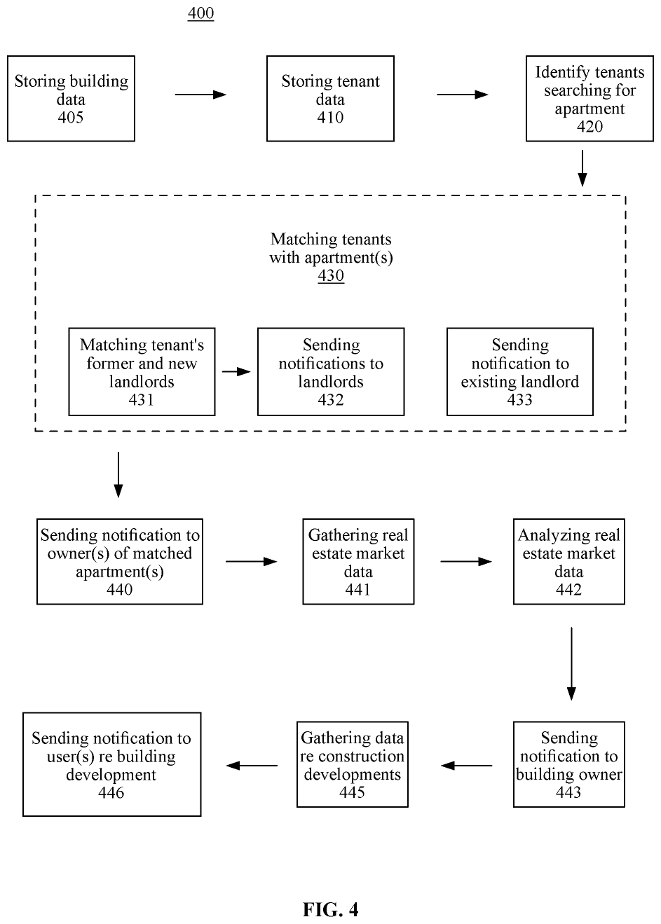

FIG. 5 is a block diagram of an exemplary a method for mapping objects on a geographical map according to the principles of the present invention.

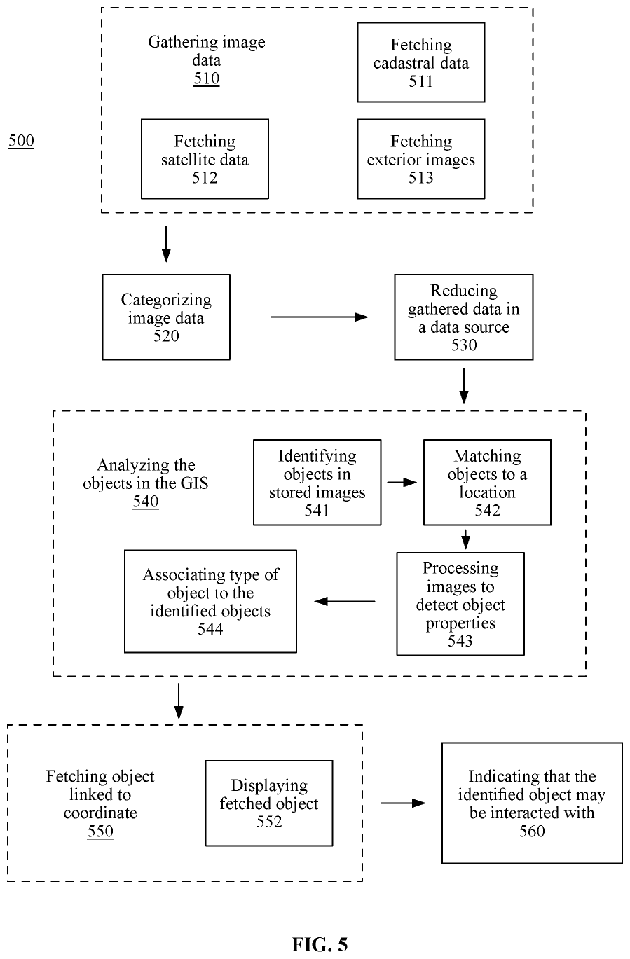

### DETAILED DESCRIPTION OF THE PREFERRED EMBODIMENT

A novel system and computer-implemented method to analyze, predict or automate financial and operative management or any activities relating to buildings based on data about the same buildings will be described hereinafter. Although the invention is described in terms of specific illustrative embodiments, it is to be understood that the embodiments described herein are by way of example only and that the scope of the invention is not intended to be limited thereby.

A system for automatically managing one or more buildings is described herein below. Broadly, the system for automatically managing one or more buildings generally aims at automating relationships between the landlord and/or the owner, the tenants and the service providers.

A computer-implemented method for automatically managing relationships between landlord and/or owner, tenants and service providers 100 is provided herein. The method 100 broadly comprises a tenant or a landlord communicating a request of work 110 to a server concerning any issue with the building or apartment, such as an element being broken, a non-functional accessory or any other improvement or repair to be executed on the building. As an example, the request of work may be related to any tasks, such as replacing a lightbulb or repairing a foundation of a building.

In some embodiments, the request 110 may comprise a category of work, notes from the tenant or landlord, a specific supplier to be contacted. In some embodiments, the request 110 may be implemented as a template document filled with required information regarding the request.

The method 100 further comprises processing the request of work 110 received from the tenant or landlord 120. The processing 120 generally comprises analysing the request to extract or use information required to prepare a request to a supplier to execute the work 130. In some embodiments, the processing 120 fetches one or more template document and replace the extracted information from the request into placeholders of the template document 122 to generate the request to the supplier 130. In some other embodiments, the processing 120 may comprise fetching a supplier associated with a category of work 124. The said association is typically predetermined or configured by the owner of the building, generally to ensure that all work relating to a category is executed by a specific supplier.

In some further embodiments, the method 100 may further comprise sending a request of approval or authorization to the landlord/owner 125. Upon reception of the request 125, the landlord/owner may accept 126 or refuse 127 the work requested by the tenant. Upon reception of the acceptation of the landlord, the processing 120 is continued/resumed. Upon reception of the refusal of the landlord, the method 100 may further comprise sending a notification of the refusal to the tenant having requested the work 128.

In some embodiments, the approval or acceptation of the owner 126 may be automatic. In such embodiments, the owner user may associate an automatic approval to categories or types of tasks and/or to predetermined suppliers. As such, when a request relates to such associated categories or tasks, the request is automatically generated and sent to the associated supplier.

In some embodiments, the step 130 may comprise sending a notification to the landlord or building owner to select the supplier to be used 132 for such specific received request of work.

The method 100 may further comprise communicating the generated request to the selected supplier 140.

Upon reception of the request, the supplier may accept or refuse the request of work 150. In the event where the supplier refuses the work 152, a notification may be sent to the landlord/building owner 153. The landlord/building owner must then select another supplier to be used 132 to execute the work. In the event where the supplier accepts the work 154, a notification may be sent to the landlord/building owner 155 that the work request was accepted. In further embodiments, the supplier may indicate the date at which the work will be executed and/or provide an estimate of time of completion of the work 156.

Upon completion of the work, the method 100 may further comprise the supplier communicating to the server the date of completion of the work 160. The step 160 may further comprise the supplier uploading or transferring data about the completed work 161, such as number of hours to complete the work, photos or images showing the completed work and/or description of the task executed. In such embodiment, the method 100 further comprises sending a notification that the work is completed to the tenant and/or to the landlord/owner 162.

In some further embodiments, the method 100 may further comprise the supplier transferring or communicating an invoice or a request of payment to the system or landlord 163. Upon reception of the invoice, the landlord may use an automated payment system or platform to pay the amount included in the sent invoice 164.

In yet other embodiments, the method may further comprise the tenant user and/or owner user communicating a rating in relation to the work requested and executed by the supplier 170. Such rating values or average rating value may be accessible to other tenant users or other owner users.

A system for automatically managing relationships between landlord and/or owner, tenants and service providers 200 is provided herein. The system 200 generally comprises a server or computer 210 connected to a network 250 and a plurality of computerized devices 220, each computerized device being connected to the network 250 and being in communication with the server 210. Each computerized device 220 may be associated or used by one of the users of the system 200, such as but not limited to the tenants, the owners, the landlords and/or the suppliers, Understandably, a computerized device 220 may be any type of device comprising a central processing device (CPU) 222, a memory 224, such as a transient memory, a display 226 and network adapter 228, such as but not limited to a desktop or laptop computer, an electronic tablet, a smart phone, a smart watch, a smart television and/or a console, etc.

The server 210 may be any type of device comprising a central processing device (CPU) 212, a memory 214, such as a transient memory and network adapter 218. The server 210 is configured to execute instructions of a program to receive the request of work from the tenants, landlord and/or owner computerized devices 110. The server is further configured to process the request 120 and to generate a supplier request of work 130. The server 210 may be configured to communicate the generated supplier request to one or more suppliers 140 through the network 250 using one or more network adaptors 218 of the server 210.

The server 210 may further be configured to fetch in a data source one or more suppliers associated with the type of work associated with the received request of work, automatically generate a supplier request and automatically send such generated supplier request to the associated suppliers.

When more than one supplier is associated to the type of work, the server 210 may be configured to accept work upon reception of the first acceptation of a supplier. In yet other embodiments, the server 210 may be configured to require each of the associated suppliers to indicate an estimate price or submit a proposal and to automatically select one supplier based on a predetermined set of rules, such as but not limited to, the lowest price, the rating of the supplier, etc.

In some embodiments, the server 210 may further be configured to receive a request from the supplier computerized device 220, the request comprising the acceptation or refusal of the communicated request of work 150. The server 210 may further be configured to generate and communicate a notification of the acceptation or refusal of work communicated by the supplier to the landlord or owner.

The server 210 may further be configured to, upon reception of the acceptation of the supplier, communicate a request of details of the work to the computerized device 210 of the supplier. In such embodiments, the server 210 is further configured to receive the details of work from the computerized device 220 of the supplier and to store the said details in memory or in a data storage in relation to the request of work.

The computerized device 220 of the supplier may be configured to display a graphical interface (GUI), such as a web interface or native interface, for the supplier user to enter details about the work, such as but not limited to, date of start of the work, estimated duration of the work, estimated end date of the work, estimated price of the work, etc. The computerized device 220 of the supplier may further be configured to display a GUI to indicate to the server 210 when the work is completed.

The server 210 may further be configured to communicate an electronic notification to any related computerized devices 220, such as the computerized device of the landlord, the tenant and/or the owner.

Understandably, the type of information processed, communicated or otherwise computed by the system is not limited to the managed property or building. The type of information may further comprise financial, operational, geographical, environmental, governmental and/or taxation data about other or extended services relating to the users or the buildings. The users may comprise any person or entity having an interest in or being in relation with the management and/or selling and/or renting or any other interaction in relation to the building or ownership of the building. Such users may comprise, but are not limited to, tenants, landlords, service providers, insurance brokers, real-estate brokers, potential buyers, potential tenants, etc.

Broadly, the system 200 may be embodied using any known technology or any technology to be developed applicable to the present invention, such as a client-server application, a web server in communication with an application server, an application running on computerized device in communication with an application server, a desktop application, etc. In some embodiments, the client computerized device 220 may be configured to execute a web browser in data communication with a server. In other embodiments, the client computerized device 220 may be configured to run a native application, such as a mobile app, configured to connect with the application server. In yet other embodiments, a computerized device may be configured to execute a stand-alone application adapted to synchronize with other devices, such as the application server.

In yet other embodiments, the system 200 may comprise a user management module configured to allow predetermined users to access limited functions or data. Understandably, some information may be accessible only to specific types or groups of users. For example, real-estate broker users may have access to real-estate specific information after submission of their accreditations and validation of such accreditations.

The system 200 may further be configured to receive data from third-party systems or external devices and/or platforms. The data may comprise data about the building, data about the suppliers, such as rating or historical data about work executed data about the tenants, such as credit score or historical renting data, data from governmental sources, such as taxation, city requirements, etc. Understandably, the data may be manually inputted or transferred to the system 200, such as in the server 210 or may be automatically downloaded or transferred from the external sources. The type and/or format of data may vary and may be, but is not limited to, text, pictures, videos, numbers, etc.

A method and a system to provide financial analysis and/or predictions regarding financial and operative management or any activities relating to building or of a plurality of buildings 300 is provided. The method 300 comprises fetching or retrieving internal and external financial data relating to the one or more buildings 310. The method further comprises processing and/or analyzing the retrieved data to calculate a plurality of prediction values 320. The method further comprises displaying and/or transferring the calculated prediction values to one or more computerized devices of users 340, such as the landlord or the owner.

In some embodiment, the method 300 may further comprise inputting data relating to the building or to a plurality of buildings 305, such as, but not limited, the address, the market value, the number of apartments, the dimensions of the building, current rental prices of each apartment, specific features of the building, dates relating to repairs or to constructions of the elements of the building, such as date of the last roof replacement, date of last renovation (such as kitchen improvements), date of construction of the building, etc.

The fetching or retrieval of financial data relating to the one or more buildings 310 may comprise retrieving financial data from one or more external sources 312. The external sources may comprise open data sources, governmental data sources, privately owned data source or any other data source repository having data relating to the financial and operative management or any activities relating to the building or to the building itself. The retrieval or fetching of the data may be executed using any method known in the art, such as web services, APIs, data files, such as but not limited to XML files, text files or JSON files, communication protocols. The external sources of data may provide data relating to, but not limited to, occupation rate of similar buildings or market value of similar buildings in predetermined area or in a predetermined radius from the building. The external sources of data may further provide data about durations of listing of buildings being offered for rent or for sale in predetermined area or in a predetermined radius from the building. The external sources of data may further provide data about average of repair or improvement spending or predictions of spending in a predetermined area or in a predetermined radius from the building.

The fetching or retrieval of financial data relating to the one or more buildings 310 may comprise retrieving financial data from one or more internal sources 314. The retrieving financial data from one or more internal sources may further comprise a user manually inputting the data through a graphical user interface on a computerized device, such as through a web application or on a native application or program being executed on the computerized device. The internal sources may further comprise data communicated by external programs or systems comprising data about the one or more buildings. The data may be automatically retrieved from the external programs through using any method known in the art, such as web services, APIs, data files, such as but not limited to XML files, text files or JSON files, communication protocols.

As examples, the data may comprise historical real estate data of an area, city, region, province, state and/or country. The data may further comprise data about repairs and upgrades made to buildings, such as data per area, city, region, province, state and/or country. The external data may further comprise cadastral information, building ownership registries, municipal or governmental taxation information or any other data publicly or privately accessible through electronic means.

In some embodiments, the method 300 may comprise filtering, cleaning, analyzing and/or classifying the retrieved data 315. The method 300 may further comprise receiving input parameters from a user to search for specific received data 316.

The processing and/or analyzing of the retrieved data to calculate a plurality of prediction values 320 may further comprise calculating financial predictions 321 based on retrieved financial data. The analysis of the retrieved data may further comprise calculating an optimal time of the year or range of dates to sell or rent a building 322 or calculate a minimum occupational rate for the ownership of a building to be profitable 323. In other embodiments, the analysis of the retrieved data further calculates a recommended or optimal selling price or rental price based on similar or comparable buildings in a predetermined area or in a predetermined radius around the one or more buildings 324. The analysis 320 may further comprise calculating or suggesting types of repairs or improvements to be executed on the building to increase the market value of the said building 325.

In further embodiments, the processing 320 may comprise identifying the most efficient marketing tools to be used to optimize and/or to increase revenues 326. The processing of the external data 320 may also comprise managing, optimizing and/or predicting hiring of suppliers and/or employees having regard to the building 327. The processing of external data 320 may further include identifying areas of a town or cities having favorable and/or unfavorable conditions to buy and/or rent buildings 328.

In some embodiments, the processing 320 comprises creating a mathematical model based on historical building data about a predetermined area 329. The mathematical model uses any relevant data, such as upgrade and repairs data, cadastral data, historical property sales data, taxation data, data from the users of the present system such as tenants and owners, etc. The data generally includes past to present data.

The data may further comprise data generated by an artificial intelligence process trained to analyze documents relating to buildings or trained to execute image recognition of documents or of photos relating to the building.

The processing 320 may further comprise computing the data to predict or evaluate financial information or financial operations to come on one or more buildings 330. The prediction typically uses the mathematical model created by the step 329. The processing 320 may further comprise predicting or estimating sales or rentals values, such as number of sales, average price, increase percentage, etc., in predetermined radius around the buildings 331. The processing 320 may further comprise predicting and/or estimating variation of the value of a building in relation to repairs and/or upgrade to the said building 332. Such prediction about the value may comprise calculating the impact of a predetermined upgrade to the building, such as upgrading a kitchen, as a function of the value of the building.

The processing 320 may also compute or calculate the predicted optimal price or optimal timing to sell a building based on historical data of the area of location of the building 333, such as prices of buildings having comparable characteristics in a predetermined radius or within a predetermined area or region.

The processing 320 may also compute or calculate the predicted optimal price or optimal timing to rent an apartment of a building based on historical data of the area of location of the building 334, such as effective rental price or asked rental prices of apartments having comparable characteristics in a predetermined radius or within a predetermined area or region.

The processing 320 may further compute or calculate the real estate market evaluation as a function of prime rates, potential risk and alerts in the area, such as but not limited to payment default rate, level of debt or debt ratio of residents in the area, etc.

A method and a system to identify and suggest potential tenants of a building to a user 400 is provided. The method 400 may comprise storing information about buildings in a data source 405, such as but not limited to status of apartment, location or coordinates of the building, owner of the building, current tenants of the apartments in the buildings. The method 400 may comprise gathering or storing tenants of a plurality of buildings in a data source 410. The method 400 further comprises identifying the tenants stored in the data source that are actively searching or looking for an apartment to rent 420. The method 400 further comprises matching the identified tenants with apartments available for rent in the buildings stored in the data source 430. The method 400 may further comprise sending an alert to one or more of the owners of a building matched with one or more tenant looking for an apartment 440.

In some embodiments, the method 400 may further comprise gathering or fetching external data about the real estate market 441. In such an embodiment, the method 400 comprises analyzing the fetched data relating to real estate 442 and sending notifications to the owner of the buildings 443. The method 400 may further comprise using an artificial intelligence program trained with real estate market data to analyse the data of the real estate market and to send a notification only with such identified data.

In yet other embodiments, the method 400 may comprise gathering or fetching external or public data about the developments or constructions sites in a predetermined radius or predetermined area around each of the building 445. The method may further comprise sending a notification about the developments to the owners or other users relating to building within the predetermined radius or area around the buildings associated with the said owners or other users 446.

The matching step 430 may further comprise matching the first owner of the identified tenant looking for an apartment and the second owner of the building suggested to the said tenant 431. In such an embodiment, the step 430 may further comprise sending a notification to the first and second owners 432. Such matching may allow exchanging or sending a tenant from a building of the first owner to one of the building of the second owner.

As examples, the method 400 may comprise sending an alert to an owner if one of the tenants of one of the buildings owned by the owner is looking to rent an apartment elsewhere 433. In such an event, the owner user may send a suggestion of another apartment of the owner and/or propose incentive to move in another apartment owned by the owner.

The identification of the tenants stored in the data source that are actively searching or looking for an apartment to rent 420 may be implemented by collecting information about browsing habits of the users, such as using cookies in internet browsers. As an example, the system may be configured to collect user inputted information, such as search strings or search criteria, when the said users are browsing on the present system or on external systems, such as an external website. The collection of data is typically executed when the users are logged or somehow connected to the present system. The collected tracking information may be analyzed by an artificial intelligence process trained to analyze and filter the collected tracking data of a user.

In other embodiments, the invention may provide tools and special profiles to certain users such as real estate agents and managers of hotels, shops, museums, etc. The system may provide marketing tools to those users that may be used within the system or outside of it. For example, a new shop may send ads within the system to users in the area around its location to promote its business. The system may further send alerts to those users, for example an alert about the rise of a building's value in an area. The system may also match those users with other users to which they may contact to conduct business with.

A computer-implemented method and a system to map objects on a geographical map 500 is provided. The method 500 comprises gathering or fetching image data from a plurality of sources 510, such as external and internal sources. The method 500 further comprises combining the image data by categories, type or any other predetermined condition, cleaning the data from any predetermined conditions and/or filtering the image data using any predetermined filters or criteria 520. The method 500 further comprises executing a program to reduce the gathered data in a data source comprising geographic data with movable and semi-movable objects and building, such as geographic information system (GIS) 530. Broadly, a GIS is a framework for managing and analyzing data. A GIS may comprise a plurality of types of data which are superposed and organized in layers over geographic locations or coordinates (2D or 3D). Such GIS is typically stored in a data base, such as a relational database. In the present application, a GIS also refers to general data source comprising data about buildings and/or objects mapped to geographic coordinates.

The step to gather or fetch data from a plurality of sources 510 may comprise but is not limited to fetching the data from cadastral data 511, satellite data 512 and/or images of the exteriors of the buildings or objects to be mapped 513. Such data may be retrieved from external data sources such as Google®, Apple®, MapQuest® or any other provider of images or applicable data.

The method 500 further comprises analyzing the objects present in the GIS 540. The analysis 540 generally comprises detecting or identifying each object present in the stored images in the GIS 541, matching or linking each identified object to a geographical location or position 542, processing each image of the GIS to detect dimensions or shape of identified objects 543 and recognizing or associating a type of object to the identified object using the detected dimensions and/or shape 544.

In some embodiments, the detection of the dimensions and/or the shape of the identified objects 543 may further comprise using an artificial intelligence module to train the detection of the said dimensions and shapes to allow the detection to be improved over time as the system processes more image data.

In yet other embodiments, recognizing or associating the type of object to the identified object 544 may further comprise using an artificial intelligence module to train the association of the type of object to be improved over time as the system processes more image data.

The method 500 generally comprises to fetch the object linked to an inputted or specified coordinate 550. Upon fetching the object linked to the inputted coordinate 550, the method 500 may further comprise displaying the fetched object 552, such as displaying the object over a map.

The method 500 further comprises associated the identified objects with a property or a category indicating that the object may be interacted with 560. In such embodiment, the method 500 further comprises interacting with the object associated with the property allowing interaction.

In some embodiments, the system 200 may comprise a communication module configured to allow data, such as messages, images, etc., to be exchanged or communicated between users. Understandably, the communication platform may have many different forms and design choices but is to generally convey information from one or a plurality of users to one or a plurality of others.

In yet another embodiment, simulating or processing 320 of the data relating to a building may further comprise gathering external data about the building, such as real estate data or general data about buildings from a specific area. As mentioned above, the external data may be any type of data related to the building, including anonymized data. The gathered data is categorized using the same categories as the data categorized 520 in association with a map. In such embodiments, the processing 320 further comprises comparing the categorized external data with categorized data 520 associated with the map 500. The processing 320 further comprises calculating a recommendation or advice based on the categorized data associated to the building and the categorized external data. As such, the method 300 comprises establishing links, trends and patterns between the two sets of data.

As an example, the processing 320 may determine from the external data that buildings of the area having improved a bathroom have increased in value. In such example, the processing 320 may further identify that the building of the user is in the same area and has not improved all bathrooms of the different apartments. The processing 320 may thus generate the advice that improving a bathroom of a building shall increases the value of a specific building based on such analysis. Understandably, the processing 320 may conclude that the recommendation is not to improve any bathroom as buildings in the area have seen no or limited increase in value following a bathroom improvement. One skilled in the art shall understand that the processing 320 may conclude or create any recommendation based on the links between the categorized information or data of the building and from the external data.

As another example, the simulation process 320 may be adapted to real estate brokers, to owners of buildings or to any other party related to the real estate market or buildings/construction industries.

In yet other embodiments, a marketing tool or module of the system 100 may use the calculated recommendations or suggestions to automatically propose modifications to ad words used in a current marketing tool of the owner, broker, agent, etc. As an example, the marketing module may suggest adding the expression “bathroom to be improved” to an ad word based on a calculated recommendation that an improved bathroom may increase the value of the renting fees. The marketing module may further be configured to identify or suggest the buildings that should be offered for renting or that should have increased marketing efforts based on the calculated suggestions. As an example, an apartment having an improved bathroom may be suggested as an apartment offered for rent or a building offered for sale based on the calculated suggestions. Otherwise, based on the calculated suggestions, the marketing module may automatically reduce the pay-per-click price of the ad word related to apartment having old or original bathrooms.

The processing 320 may further comprise comparing different buildings of the user or buildings associated with an owner and/or user with other buildings within a predetermined distance of the buildings of the user or of a designated position. The comparison may be performed upon any criterion based on the identified or predetermined categories of the buildings and/or of the external data, such as but not limited to rent price, sale price, dimensions, recent improvements, characteristics of the surroundings, such as presence of a park, a school, a public pool, a market, etc.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A computer-implemented method for analyzing, predicting or automating the financial and operative management of at least one building, the method comprising:
retrieving from a server data relating to the at least one building;
categorizing the retrieved data using categories;
retrieving external data about the real estate market and other buildings;
categorizing the retrieved external data using the categories;
comparing categorized data relating to the at least one building with the categorized external data for each category;
calculating prediction values based on the compared categories.

2) The computer-implemented method of claim 1, retrieving data relating to the at least one building comprising retrieving any one of the following:
cadastral data about the at least one building;
current rental prices of apartments of the at least one building;
dimensions of the at least one building;
market value of the at least one building;
specific features of the at least one building; and
improvements to the at least one building.

3) The computer-implemented method of claim 1, the retrieval of external data comprising retrieving data relating to buildings similar to the at least one building.

4) The computer-implemented method of claim 1, the retrieval of external data comprising retrieving external data from open data sources, governmental data sources and privately owned data sources.

5) The computer-implemented method of claim 1, wherein the retrieved external data comprises at least one of occupation rate of the other buildings, market value of the other buildings, duration of sale listings for the other buildings and duration of rental listings for the other buildings.

6) The computer-implemented method of claim 1, the method further comprising filtering, cleaning, analyzing and classifying the data relating to the at least one building.

7) The computer-implemented method of claim 1, the method further comprising dynamically determining the categories.

8) The computer-implemented method of claim 1, the method further comprising generating a suggestion based on the calculated prediction values.

9) The computer-implemented method of claim 8, the suggestion being related to promotion of the building.

10) The computer-implemented method of claim 1, the method further comprising deriving at least one of the following from the calculated prediction values:
a target sale price of the at least one building;
target rental prices of apartments of the at least one building;
target improvements of the at least one building;
target marketing terms for the promotion of the at least one building;
target marketing strategies for the promotion of the at least one building.

11) A computer-implemented method for automatically managing relationships between landlord and/or owner, tenants and service providers in relation to a building, the method comprising:
communicating a request of work to a server from a party involved with the building concerning an issue in relation to the building;
processing the request of work received from the building party to generate a request of executing the work;
matching the generated request of work to one of the service providers;
communicating the generated request of executing the work to the matched service provider;
the receiving service provider sending a reply of acceptance or of refusal of the received request of executing the work; and
the service provider communicating to the server a date of completion of the work to be executed upon completion of the said work.

12) The method of claim 11, the request of work comprising a category of work, notes from the building party and a specific service provider to be contacted.

13) The method of claim 11, the processing of the request of work further comprising:
extracting information from the request of work relevant to the matching service provider;
creating a request for executing the work based on the extracted information.

14) The method of claim 13, the processing of the request of work further comprising:
fetching one or more template documents;
replacing the extracted information into placeholders of the template document to generate the request for executing the work to the matching service provider.

15) The method of claim 11, the processing of the request of work further comprising:
associating a predetermined category to the type of work requested;
fetching a service provider associated with the predetermined category of work.

16) The method of claim 15, wherein one of the service providers associated with the predetermined category is associated to the building, the method further comprising automatically sending the generated request of executing the work to the associated service provider.

17) The method of claim 11, wherein a tenant computerized device sends the request of work, the method further comprising:
sending a request of approval to the computerized device of the landlord/owner;
the computerized device of the landlord/owner sending a reply comprising approval or refusal of the received request of approval; and
continuing the processing if the reply comprises an approval.

18) The method of claim 17 further comprising sending a notification of the refusal to the computerized device of the tenant if the reply comprises a refusal.

19) The method of claim 17, wherein the sending a request of approval is automatic if some predetermined criteria are met.

20) The method of claim 11, upon receipt of the reply of refusal of work by the service provider, the method further comprising the landlord/owner selecting another service provider associated to the generated request to execute work and sending the amended generated request to execute work to the other service provider.

21) The method of claim 11, the method further comprising the service provider inputting and sending to the server the date at which the work is to be executed and an estimate of time of completion of the work.

22) The method of claim 11, the method further comprising the service provider transferring data to the server about the completed work and sending a notification that the work is completed to a computerized device of the tenant and/or to a computerized device of the landlord and/or owner.

23) A system for automatically managing relationships between landlord and/or owner, tenants and service providers, in relation to a building, the system comprising:
a network;
a computerized device of a party involved with the building, the computerized device being in communication with the network, the computerized device being configured to:
create at least one request of work concerning an issue in relation to the building, the request of work comprising a type of work associated with the issue;
communicate the created request of work to a server, and
receive notifications from the server;
a data source comprising:
data relating to the building;
a plurality of types of work;
data relating to the service providers, each of the service providers being associated with at least one of the types of work;
a server in communication with the network, the server being configured to:
process the request of work received from the computerized device of the building party to generate a request of executing the work;
communicate the generated request of executing the work to a computerized device of one of the service providers;
receive and store a date of completion of the work from the computerized device of one of the service providers;
matching the receive request of work to one of the service providers;
the computerized device of one of the service providers, the computerized device being in communication with the network, the computerized device being configured to:
receive the generated request of executing the work from the server;
communicate to the server a reply of acceptance or of refusal in relation with the received request of executing the work;
communicate to the server a date of completion of the work to be executed upon completion of work of the request of executing the work.

24) The system of claim 23, the server being further configured to:
associate a predetermined category to the type of work in the received request of work;
fetch one or more of the service providers associated with the predetermined category of work.

25) The system of claim 23, the computerized device of a service provider being further configured to create and communicate to the server an approval or refusal notification in relation to the generated request of executing the work.

26) The system of claim 23, the data source comprising an association between one or more of the service providers and the building.

27) The system of claim 23, the server being configured to automatically match one of the service providers to the generated request of work and to automatically communicate the generated request for executing work to the computerized device of the service provider.

28) A computer-implemented method to identify and suggest potential users with interest for a building, the method comprising:
storing information about buildings in a data source, the information comprising information about buildings offered for rent or for sale and users related to each of the buildings;
identifying the users stored in the data source that are actively searching for one of the buildings to rent or to buy in the data source;
matching the identified users with the buildings available for rent or for sale stored in the data source;
sending a notification to one or more of the users related to each of the buildings matched with the identified users actively searching for one of the buildings to rent or to buy.

29) The computer-implemented method of claim 28, the method comprising:
categorizing information about the buildings in the data source using categories;
retrieving external data about buildings within a distance of the buildings in the data source;
categorizing the retrieved external data using the categories;
comparing categorized data relating to at least one of the buildings of the data source with the categorized external data for each of the categories;
calculating a matching score between one of the identified users and one of the buildings based on the compared categories.

30) The computer-implemented method of claim 29, the categorizing of information about the buildings in the data source comprising using an artificial intelligence module to identify the categories.

31) The computer-implemented method of claim 28, the external data being retrieved comprising data about the real estate market.

32) The computer-implemented method of claim 28, the external data being retrieved comprising data of development or construction sites, the method further comprising:
identifying the buildings of the data source being within a predetermined distance of building developments or construction sites;
sending a notification to users relating to the buildings within the predetermined distance of the building developments or construction sites.

33) The computer-implemented method of claim 28, the storing of information further comprising owners of each of the buildings in the data source, the method further comprising:
matching the buildings of the data source meeting criteria associated with the identified users searching;
matching a first owner associated with a building related to one of the identified users searching and a second owner associated with one of the buildings matched to the identified user searching;
sending a notification to the first and second owners about the matching of the first and second owners.

34) The computer-implemented method of claim 28, the identification of the users stored in the data source that are actively searching for one of the buildings to rent or to buy in the data source further comprising collecting information about browsing habits of the users when the said users are searching for buildings in the data source.

35) The computer-implemented method of claim 34, the method further comprising using an artificial intelligence process trained to analyze and filter the collected information about browsing habits of the users.

36) A system to identify and suggest a user with interest for a building, the system comprising:
a network;
a data source comprising:
data about buildings, the information comprising data about buildings offered for rent or for sale; and
data about users searching for buildings for rent or for sale and users related to the buildings;
a computerized device of a user involved with the building, the computerized device being in communication with the network, the computerized device being configured to receive a notification from a server;
a server in communication with the network, the server being configured to:
identify one or more of the users of the data source that are searching for one of the buildings to rent or to buy;
match the identified users with one or more of the buildings in the data source that are available for rent or for sale;
send a notification to the computerized device of one or more users associated with the one or more of the buildings, the notification comprising the matching users and the associated buildings.

37) The system of claim 36, the data source further comprising external data about buildings within a predetermined distance of the buildings in the data source, the server being further configured to retrieve the external data about buildings and to store the retrieved external data in the data source.

38) The system of claim 37, the server being further configured to:
categorize information about the buildings in the data source using categories;
categorize the retrieved external data using the categories;
compare the categorized data relating to at least one of the buildings of the data source with the categorized external data for each category;
calculate a matching score between the user and one of the buildings based on the compared categories.

39) The system of claim 38 further comprising an artificial intelligence module configured to be trained with the external data and to identify the categories based on the training.

40) The system of claim 37, the categories being dynamically identified.

41) The system of claim 37, the external data comprising building developments or construction sites, the server being further adapted to:
identify buildings of the data source being within a predetermined distance of the building developments or construction sites; and
send a notification to the one or more users relating to the buildings within the predetermined distance of the building developments or construction sites.

42) A computer-implemented method to map objects on a geographical map comprising:
retrieving image data of a plurality of buildings from a plurality of data sources;
categorizing the retrieved image data using categories;
reducing the retrieved image data in a geographic information data source (GIS) comprising movable and semi-movable objects and buildings;
identifying each object present in the categorized image data and storing each object in the GIS;
associating each of the identified objects to a geographical location;

43) The computer-implemented method to map objects on a geographical map of claim 42, the retrieval of image data from a plurality of data sources further comprising fetching image data from any of the followings: cadastral data, satellite data images of the exteriors of the buildings and image data relating to objects to be mapped.

44) The computer-implemented method to map objects on a geographical map of claim 42, the detection of the dimensions and/or the shape of the identified objects comprising using an artificial intelligence module to train the detection of the said dimensions and/or shapes to allow the detection to be improved over time as the additional image data is mapped.

45) The computer-implemented method to map objects on a geographical map of claim 42, the association of each of the identified object to a geographical location comprising using an artificial intelligence module to train the detection of the said dimensions and/or shapes to allow the detection to be improved over time as the additional image data is mapped.

46) The computer-implemented method of claim 42, the method further comprising dynamically determining the categories.

47) The computer-implemented method of claim 42, the method further comprising:
cleaning the data from any predetermined conditions;
filtering the retrieved image data using any predetermined filters.

48) The computer-implemented method of claim 42, the method further comprising:
detecting dimensions and/or shapes of each of the identified objects;
wherein the association of a type of object to each of the identified objects uses the detected dimensions and/or shape.

49) The computer-implemented method of claim 42, the method further comprising fetching from the GIS one or more objects linked to a specified coordinate.

50) The computer-implemented method to map objects on a geographical map of claim 49, the method further comprising displaying the fetched object over a map.

51) The computer-implemented method of claim 42, the method further comprising marking the identified objects as being an interactive object.

52) The computer-implemented method to map objects on a geographical map of claim 51, the method further comprising interacting with the interactive object.
